(19) United States
(12) Patent Application Publication
(10) Pub. No.: US 2010/0053224 A1
(43) Pub. Date: Mar. 4, 2010

(54) PLASMA DISPLAY DEVICE

(76) Inventors: Yasunobu Hashimoto, Kawasaki (JP); Yasuyuki Kudo, Fujisawa (JP); Naoki Takada, Yokohama (JP); Hiroyuki Matsushima, Yokosuka (JP)

Correspondence Address: MILES & STOCKBRIDGE PC, 1751 PINNACLE DRIVE, SUITE 500, MCLEAN, VA, 22102-3833, US

(21) Appl. No.: 12/439,181

(22) PCT Filed: Nov. 6, 2006
(86) PCT No.: PCT/JP2006/322077

§ 371 Date: Aug. 10, 2009

(51) Int. Cl. G09G 5/10

(52) U.S. Cl. 345/690

(57) ABSTRACT

The characteristics of a filter are controlled based on index information relating to the power consumption of an address driver that drives address electrodes for selecting light emission or no light emission of display cells based on display data, and filtering is performed on the display data in the arrangement sequence of display cells for a direction perpendicular to the direction in which the address electrodes extend on a display screen, thereby controlling the characteristics of the filter so as to suppress high-frequency components in the display data when the power consumption of the address driver is large to reduce the number of changes in the potentials of the address electrodes, enabling reduction of the power consumption of the address driver while suppressing image quality deterioration.

### TECHNICAL FIELD

The present invention relates to a plasma display device.

### BACKGROUND ART

A plasma display panel (PDP) has an electrode matrix including a group of scan electrodes for row selection and a group of address electrodes for column selection. Unit display areas are defined at the intersections of the scan electrodes and the address electrodes, and one display element is arranged in each of the unit display areas. In a commercialized surface-discharge-type PDP, two electrodes are arranged in each row, and only one of these electrodes is used for row selection. Thus, from the perspective of selection of display elements, the configuration of electrodes in a surface-discharge-type PDP can be regarded as having a simple matrix as with those of other PDPs.

Displayed content is determined by row-based addressing, i.e., performing address selection for each row. An address period for one frame in which addressing is performed is divided into a number of row selection periods, the number being the same as the number of rows in the screen. Each scan electrode is activated by being exclusively biased to a predetermined potential in any one of the row selection periods, and display data for one row are output from all the address electrodes in parallel in synchronization with the activation of the scan electrode. In other words, the potentials of all the address electrodes are controlled concurrently according to the display data.

Such driving method has a problem in that charging/discharging of capacitances between the adjacent address electrodes and between the address electrodes and the other electrodes (for example, the scan electrodes) occurs, resulting in a large amount of power wasted for it. Although capacitances also exist between the scan electrodes, the potentials of the scan electrodes change regularly, not depending on the display data, and thus, power can be collected using LC resonance.

Also, in terms of the number of potential changes in each electrode during addressing, the potentials of the scan electrodes change only during row selection, while the potentials of the address electrodes change very often. In particular, in addressing for an image containing a large amount of high-frequency components, the potentials of the address electrodes change frequently. In such a case, plenty of power is consumed for charging the capacitances between the electrodes.

Several countermeasures have been proposed for this problem. For example, Japanese Laid-open Patent Publication No. 7-152341 discloses masking less significant bits in display data when the power consumption of an address driver that drives address electrodes is increased. More specifically, Japanese Laid-open Patent Publication No. 7-152341 discloses masking display data for some sub-frames from among a plurality of sub-frames constituting one frame. Consequently, potential changes of the address electrodes for the sub-frames for which the display data are masked are suppressed, reducing the power consumption. However, in this method, since the number of sub-frames that substantially serve for grayscale expression, the grayscale expression capability will be lowered. Accordingly, the displayed image has a rough grayscale, resulting in image quality deterioration.

Also, for example, Japanese Laid-open Patent Publication No. 11-282398 discloses that when the power consumption of an address driver is increased, the address scanning sequence (row selection sequence) is changed with reference to the arrangement of display data for the sub-frames so that the number of changes in the potentials of the address electrodes is decreased. However, this method requires a circuit for changing the scanning sequence according to the display data for the sub-frames, and thus, the circuit configuration becomes complex. Also, it is difficult to adapt this method to any kind of display data.

[Patent Publication 1] Japanese Laid-open Patent Publication No. 7-152341

[Patent Publication 2] Japanese Laid-open Patent Publication No. 11-282398

### SUMMARY OF THE INVENTION

An object of the present invention is to reduce the power consumption of an address driver while suppressing image quality deterioration with a simple circuit configuration.

A plasma display device according to the present invention comprises: a filter for filtering display data; a plurality of address electrodes for selecting light emission or no light emission of display cells; and an address driver for driving the address electrodes based on the filtered display data, wherein: a characteristic of the filter is controlled based on reference index information relating to power consumption of the address driver; and the filtering is performed on the display data in an arrangement sequence of display cells for a direction perpendicular to a direction in which the address electrodes extends on a display screen displaying an image displayed based on the display data.

According to the present invention, when an address driver consumes a large amount of power, the characteristics of a filter are controlled so as to suppress high-frequency components in display data, enabling reduction of the number of changes in the potentials of the address electrodes while suppressing image quality deterioration.

### BRIEF DESCRIPTION OF THE DRAWINGS

FIG. 1 is a diagram illustrating an example configuration of a plasma display device according to a first embodiment of the present invention;

FIG. 2 is a diagram illustrating a configuration of a main part of an address driver;

FIG. 3 is a diagram illustrating an example of a drive sequence for a plasma display device;

FIG. 4 is a diagram illustrating an example configuration of a plasma display device according to a second embodiment of the present invention;

FIG. 5 is a diagram illustrating an example configuration of a plasma display device according to a third embodiment of the present invention;

FIG. 6 is a diagram illustrating an example configuration of a plasma display device according to a fourth embodiment of the present invention;

FIG. 7 is a diagram illustrating another example configuration of a plasma display device according to a fourth embodiment of the present invention; and

FIG. 8 is a diagram illustrating another example configuration of a plasma display device according to a fourth embodiment of the present invention.

### DETAILED DESCRIPTION OF THE PREFERRED EMBODIMENTS

Hereinafter, embodiments of the present invention will be described with reference to the drawings.

### First Embodiment

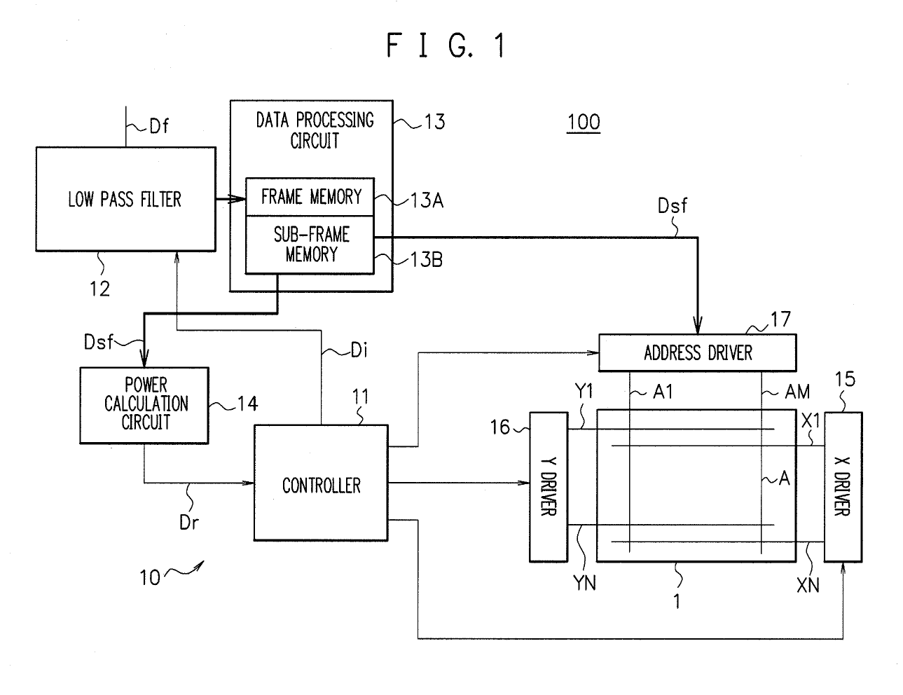

FIG. 1 is a diagram illustrating an example configuration of a plasma display device according to a first embodiment of the present invention.

A plasma display device 100 includes an alternate current-driven (AC-type) plasma display panel (PDP) 1, which is a thin-model color display device, and a drive unit 10 for the PDP 1. The plasma display device 100 is used as, e.g., a wall-hanging TV receiver, or a monitor for a computer system.

The PDP 1 includes a plurality of display cells arranged in a matrix, the plurality of display cells constituting a screen with M columns and N rows. The PDP 1 has a three-electrode surface discharge structure in which X electrodes (first main electrodes) X1 to XN and Y electrodes (second main electrodes) Y1 to YN, which constitute electrode pairs for causing lighting sustain discharge (also referred to as “display discharge”), and address electrodes (third electrodes) A1 to AM for selecting lighting (light emission) or no lighting (no light emission) of the relevant display cells are crossed in the respective display cells. Hereinafter, the X electrodes X1 to XN are individually or collectively referred to as an X electrode Xi, and the Y electrodes Y1 to YN are individually or collectively referred to as a Y electrode Yi, and i represents a numerical subscript. Similarly, the address electrodes A1 to AM are individually or collectively referred to as an address electrode Aj, and j represents a numerical subscript.

The X electrodes Xi and the Y electrodes Yi are arranged alternately in parallel, and the address electrodes Aj are arranged in a direction perpendicular to the electrodes Xi and Yi (so that the address electrodes Aj intersect with the electrodes Xi and Yi). The electrodes Xi and Yi extend in the row direction (horizontal direction) of the screen, and the Y electrodes Yi are used as scan electrodes for selecting display cells on a row-by-row basis during addressing. Also, the address electrodes Aj extend in the column direction (vertical direction) of the screen, and are used as electrodes for selecting display cells on a column-by-column basis during addressing.

In the substrate surface, the areas in which the X electrodes Xi and the Y electrodes Yi, and the address electrodes Aj intersect with each other are display areas (i.e., the screen), and the intersections of the Y electrodes Yi and the address electrodes Aj and their respective adjacent X electrodes Xi form the respective display cells. These display cells correspond to pixels, enabling the PDP 1 to display two-dimensional images.

The drive unit 10 is provided for selectively lighting numerous display cells constituting the screen with M columns and N rows, and includes a controller 11, a low pass filter 12, a data processing circuit 13, a power calculation circuit 14, an X driver 15, a Y driver 16 and an address driver 17. Pixel-based frame data (display data) Df indicating the brightness levels (grayscale levels) of each of colors, R (red), G (green) and B (blue), are input from an external device such a TV tuner or a computer to the drive unit 10 together with various types of synchronization signals.

The controller 11 controls the low pass filter 12, the X driver 15, the Y driver 16 and the address driver 17 based on externally-input signals (the frame data Df and the various types of synchronization signals).

The low pass filter 12 is a filter capable of suppressing high-frequency components in input data, and filters externally-input frame data Df. The filter characteristics of the low pass filter 12 are controlled based on coefficient designation data Di from the controller 11. For example, the cutoff frequency of the low-pass filter 12 is controlled according to the coefficient designation data Di.

The data processing circuit 13 processes the frame data filtered by the low pass filter 12, and outputs the frame data to the power calculation circuit 14 and the address driver 17. More specifically, the data processing circuit 13 once stores the frame data Df filtered by the low pass filter 12 in frame memory 13A, and then, converts the frame data Df into sub-frame data Dsf for grayscale display and stores the sub-frame data Dsf in sub-frame memory 13B. Also, the data processing circuit 13 serially transfers the sub-frame data Dsf stored in the sub-frame memory 13B to the address driver 17, and also supplies the sub-frame data Dsf to the power calculation circuit 14. Here, in the sub-frame data Dsf obtained as a result of conversion of the frame data Df, the values of the respective bits indicate whether or not it is necessary to light the display cells, and to be exact, whether or not address discharge is needed for the display cells, for the sub-frame.

The power calculation circuit 14 calculates the power consumption value of the address driver 17 based on the sub-frame data Dsf supplied from the data processing circuit 13. Arithmetic expressions for calculating power consumption values are registered in advance in the power calculation circuit 14, and the power consumption value of the address driver 17 is calculated according to the arithmetic expressions. Also, the power calculation circuit 14 outputs data Dr, which indicates the power consumption value obtained as a result of the calculation, to the controller 11. The controller 11 determines the coefficient of the low pass filter 12 based on the data Dr.

The X driver 15 drives the X electrodes Xi and controls the potentials of the X electrodes Xi. The X driver 15 includes a circuit that repeatedly performs a discharge, and the X driver 15 supplies a predetermined voltage to the X electrodes Xi. Also, the Y driver 16 drives the Y electrodes Yi and controls the potentials of the Y electrodes Yi. The Y driver 16 includes a circuit that performs a line-sequential scan and a circuit that repeatedly performs a discharge, and supplies a predetermined voltage to the Y electrodes Yi.

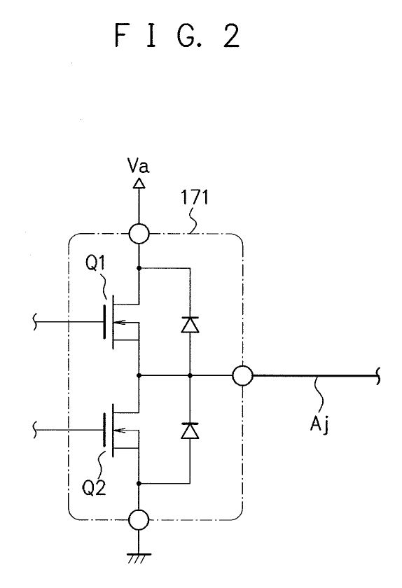

The address driver 17 drives the address electrodes Aj and controls the potentials of the address electrodes Aj. The address driver 17 includes a circuit that selects rows to be displayed, and supplies a predetermine voltage to the address electrodes Aj. The address driver 17 includes one switching circuit 171 having a push-pull configuration, which is illustrated in FIG. 2, for each of the address electrodes Aj. The address driver 17 can independently controls the potential of each of the address electrodes Aj according to the sub-frame data Dsf.

For example, when a switching element Q1 in the switching circuit 171 is turned on, the address electrode Aj is biased to a predetermined power supply potential (Va). Also, for example, when a switching element Q2 in the switching circuit 171 is turned on, the address electrode Aj has a ground potential.

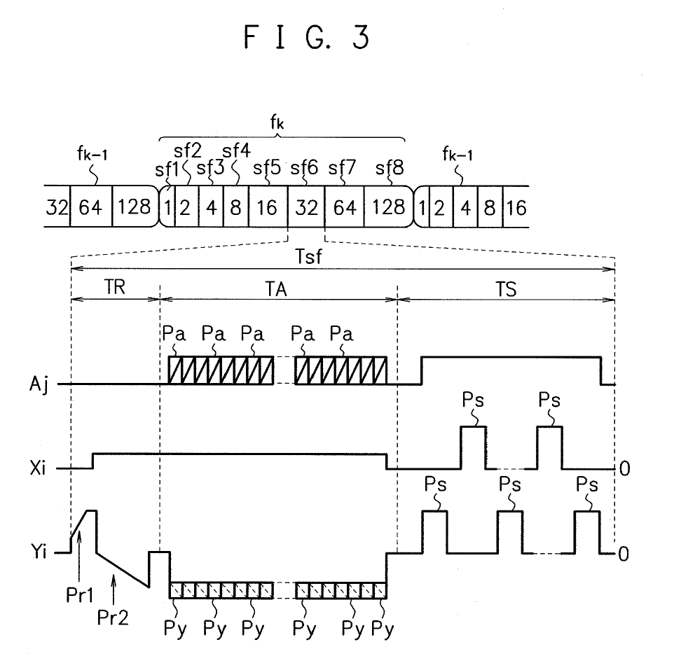

The driving of the plasma display device 100 illustrated in FIG. 1 is controlled according to a drive sequence (which will be described later), an example which is illustrated in FIG. 3, and a display image, which is based on the frame data Df input from the external device, is displayed on the PDP 1. During the operation, the plasma display device 100 suppresses high-frequency components in the input frame data Df as appropriate by filtering the frame data Df, based on the amount of power consumed by the address driver 17, which is used as a reference index. Consequently, the power consumed by charge and discharge of capacitances between the address electrodes Aj, and between the address electrodes Aj and the main electrodes Xi and Yi during addressing.

The plasma display device 100 according to the present embodiment uses the power consumption value of the address driver 17 calculated from the sub-frame data Dsf obtained as a result of conversion of the input frame data Df, as an index of the power consumed by the address driver 17. Thus, the amount of suppression of high-frequency components in the frame data Df can be changed according to the sub-frame data Dsf.

More specifically, the power calculation circuit 14 calculates the power consumption value of the address driver 17 based on the sub-frame data Dsf, and outputs the calculated power consumption value to the controller 11. The controller 11 determines the coefficient of the low pass filter 12 according to the power consumption value, and outputs coefficient designation data Di to the low pass filter 12 to control the filter characteristics. The determined filter coefficient is applied from the frame data Df in the next frame.

Next, the configuration of the low pass filter 12 will be described. The low pass filter 12 performs filtering for a horizontal direction (direction perpendicular to the direction in which the address electrodes Aj extend, and in which the electrodes Xi and Yi extend) on the screen with M columns and N rows in the PDP 1. The low pass filter 12 may perform filtering for a vertical direction (direction in which the address electrodes Aj extend) in addition to the horizontal direction, that is, for both directions.

The case where filtering is performed in the arrangement sequence of the display cells regardless of R, G or B for the horizontal direction on the screen with M columns and N rows in the PDP 1 will be described. It is assumed that image data for each of horizontal lines (referred to as “i lines”) corresponding to the electrodes Xi and Yi is Li(x). “x” is the coordinate in the horizontal direction of a pixel, and is indicated by pixel pitch unit in the horizontal direction. Hereinafter, the length is indicated by pixel pitch unit.

Where image data filtered by the low pass filter 12 is Li_{f}(x), the low pass filter 12 can be expressed by expressions (1) and (2).

$$\begin{matrix}[ Formula 1 ] & \\ {Li}_{f} ( x ) = {\sum }_{k = - N}^{N} {a}_{k} Li ( x - k ) & ( 1 ) \\ {a}_{k} = \{ \begin{matrix}1 - \frac{2}{2 N + 1} S & ( k = 0 ) \\ \frac{1}{π k} sin ( π k {ω}_{0} ) - {ω}_{0} + 1 - \frac{2}{2 N + 1} S & ( k \geq 1 ) \\ {a}_{- k} & ( k \leq 1 )\end{matrix} & ( 2 )\end{matrix}$$

Here, ω₀ is a cutoff frequency determined based on a pitch twice the pitch of the data sequences, and ω₀=1 corresponds to the Nyquist limit. S in expression (2) can be determined by expression (3).

$$\begin{matrix}[ Formula 2 ] & \\ S = {\sum }_{l = 1}^{N} ( \frac{1}{π l} sin ( π l {ω}_{0} ) - {ω}_{0} + 1 ) & ( 3 )\end{matrix}$$

The value of ω₀ is controlled according to the power consumption value of the address driver 17 calculated by the power calculation circuit 14, thereby the filter characteristics of the low pass filter 12 being controlled. The value of ω₀ is controlled as follows, for example.

When the power consumption value of the address driver 17 is sufficiently small, it is unnecessary to limit a frequency band for the low pass filter 12, and thus, the controller 11 sets the value of ω₀ to 1, which provides the Nyquist limit, or a value exceeding 1. This value of ω₀ is determined as a predetermined upper limit value ω₀ₘₐₓ. Also, it is assumed that the target value of the power consumption of the address driver 17 is Pₘₐₓ.

The controller 11 compares the power consumption value of the address driver 17 calculated by the power calculation circuit 14 and the target value Pₘₐₓ with each other, and if the controller 11 has determined that the power consumption value of the address driver 17 equals to or exceeds the target value Pₘₐₓ, the controller 11 decreases the value of ω₀. Meanwhile, if the controller 11 has determined that the power consumption value of the address driver 17 is lower than the target value Pₘₐₓ, the controller 11 increases the value of ω₀. However, the controller 11 does not set the value of ω₀ to a value exceeding ω₀ₘₐₓ.

As described above, when the power consumption value of the address driver 17 exceeds a predetermined value, the controller 11 successively performs control so as to lower the value of ω₀ (the cutoff frequency of the low pass filter 12) to suppress high-frequency components in the image data, enabling the power consumption of the address driver 17 to be substantially suppressed to a value equal to or lower than the target value.

Although the above description has been given in terms of the case where display data is filtered only in the arrangement sequence of the display cells regardless of R, G or B in the horizontal direction, control may be performed so that: filtering of display cells is performed by the same color; and when the cutoff frequency of the filter in this case reaches the lower limit, filtering is performed in the arrangement sequence of the display cells.

In other words, when the power consumption value of the address driver 17 exceeds a predetermined value, the cutoff frequency is lowered, and filtering of the display cells is performed by the same color by means of the low pass filter 12 (color-based filtering). When the cutoff frequency in this color-based filtering reaches the lower limit, filtering in the arrangement sequence of the display cells (indiscriminate filtering) is performed by means of the low pass filter 12.

Also, the case where filtering is performed for the vertical direction on the screen with M columns and N rows in the PDP 1 is similar to the case for the horizontal direction, and it is only necessary to assume that image data for each of vertical lines (referred to as “j lines”) corresponding to the address electrodes Aj is Lj(y), and replace x with y. “y” is the coordinate in the vertical direction of a pixel, and is indicated by pixel pitch unit in the vertical direction.

Next, a method for the power calculation circuit 14 to calculate the power consumption value of the address driver 17 will be described.

It is assumed that: the direction in which the address electrodes Aj extend is the column direction; the direction perpendicular to the direction in which the address electrodes Aj extend is the row direction; and sub-frame data Dsf for the display cell in the i-th row and the j-th column is expressed by d(i,j)[d(i,j)={0,1}]. The power consumed by the address driver 17 includes power for charging of the inter-electrode capacitances and power consumed by gas discharge during addressing. Also, the inter-electrode capacitances can be classified into the inter-electrode capacitances between the address electrodes Aj and the inter-electrode capacitances between the address electrodes Aj and the electrodes Xi and Yi.

Power for charging of an inter-electrode capacitance between address electrodes Aj can be expressed by the difference u(i,j) in display data between display cells adjacent to each other, and defined by expression (4).

[Formula 3]

u(i,j)=d(i,j+1)−d(i,j) [u(i,j)={−1,0,1}] (4)

As the sub-frame data changes in the row sequence, the potentials of the address electrodes Aj change, and when the charge energy between the address electrodes Aj is increased, power is supplied from the address driver 17. Where power for charging of an inter-electrode capacitance between address electrodes Aj when the sub-frame data in the i-th row is changed into the sub-frame data in the (i+1)-th row is fₘ(u(i,j),u(i+1,j)), expression (5) can be obtained.

[Formula 4]

fₘ(u,u)=0 (u={−1,0,1})

fₘ(u,0)=0 (u={−1,0,1})

fₘ(0,u)=p₁ (u={−1,1}) (5)

fₘ(−1, 1)=p₂

fₘ(1,−1)=p₂

Here, p₁ and p₂ are determined by the inter-electrode capacitance between the address electrodes Aj and the address pulse waveform.

The other type of inter-electrode capacitance is an inter-opposing electrode capacitance between an address electrode Aj and electrodes Xi and Yi as described above. Power is supplied from the address driver 17 when sub-frame data is changed from “0” to “1”. Accordingly, where power for charging of an inter-opposing electrode capacitance for an address electrode Aj when the sub-frame data in the i-th row is changed into the sub-frame data in the (i+1)-th row is fₚ(d(i,j), d(i+1,j)), expression (6) can be obtained.

[Formula 5]

fₚ(0,1)=p₃

fₚ(d₁,d₂)=0 ((d₁d₂)≠(0,1)) (6)

Here, p₃ is determined by the inter-opposing electrode capacitance and the address pulse waveform.

In addition, power supplied by the address driver 17 includes power for gas discharge during addressing, i.e., what is called “address discharge power”. The address discharge power is supplied when the sub-frame data is “1”. Where the address discharge power per display cell is f_{d}(d(i,j)), expression (7) can be obtained.

[Formula 6]

f_{d}(d)=p₄d (7)

The sum of the power fₘ for charging of the inter-address electrode capacitance, the power fₚ for charging of the inter-opposing electrode capacitance and the address discharge power f_{d}, is the power supplied by the address driver 17, and power supplied by the address driver 17 to the PDP 1, i.e., power consumption P_{A} can be calculated by expression (8).

$$\begin{matrix}[ Formula 7 ] & \\ {P}_{A} = {\sum }_{i = 0}^{N} {\sum }_{j = 0}^{M} \{ \begin{matrix}{f}_{m} ( u ( i , j ) , u ( i + 1 , j ) ) + \\ {f}_{p} ( d ( i , j ) , d ( i + 1 , j ) ) + {f}_{d} ( d ( i , j ) )\end{matrix} \} & ( 8 )\end{matrix}$$

In expression (8), the screen has a size of M columns and N rows in terms of display cell unit, and inter-electrode capacitances between dummy address electrodes outside the screen and the address electrodes is taken into account. Changing from the state before the address period to the state for the first row and shifting from the state for the N-th row to the state after the address period are also taken into account. Accordingly, the definition of data d(i,j) is expanded to set the value as indicated by expression (9).

[Formula 8]

d(0,j)=d(N+1,j)=d(i,0)=d(i,M+1)=0 (9)

According to expression (8), the power consumption value of the address driver 17 for one sub-frame can be calculated, and thus, calculation of power for all the sub-frames in one frame enables calculation of power consumption per frame. The power consumption value per frame calculated by the power calculation circuit 14 may be used directly for control of the low pass filter 12, or an average value of a plurality of frames may also be used for the control.

FIG. 3 is a diagram illustrating an example of a drive sequence for the plasma display device according to the present embodiment.

An image includes a plurality of frames f in chronological order such frames fk−1, fk and fk+1 as illustrated in FIG. 3 (indexes indicate the display sequence). For displaying an image, a grayscale is reproduced by means of binary lighting control for each pixel, and thus, each of the frames f are divided into, for example, eight sub-frames sf1, sf2, sf3, sf4, sf5, sf6, sf7 and sf8.

The sub-frames sf1 to sf8 are weighted so that the relative brightness ratio becomes, for example, approximately 1:2:4:8:16:32:64:128, and the number of lighting sustain discharges for each of the sub-frames sf1 to sf8 is set. In the example illustrated in FIG. 3, the sub-frame sf1 has the lowest brightness weighting, and the brightness weighting is increased in the order of the sub-frames sf2, sf3, . . . , and the sub-frame sf8 has the highest brightness weighting. Combination of lighting/no lighting for respective sub-frames enables setting of 256-level brightness for each of the colors, R, G and B, and the number of colors that can be displayed amounts to the cube of 256.

A sub-frame period Tsf assigned to each of the sub-frames sf1 to sf8 includes a reset period TR, an address period TA and a sustain period TS. In the reset period TR, charge distribution of the display cells is reset. In the address period TA, charge distribution according to the content to be displayed (sub-frame data) is formed by means of row selection. In the sustain period TS, the lighted state is sustained for securing the brightness according to the grayscale level.

More specifically, in the reset period TR, first, a positive ramp wave Pr1 is applied concurrently to the Y electrodes Yi to form wall charges. Subsequently, a negative ramp wave Pr2 is applied concurrently to the Y electrodes Yi to adjust the wall charge amounts in the display cells.

In the address period TA, wall charges necessary for sustaining a lighted state are formed only in the display cells to be lighted during the sustain period TS. In a state in which all the X electrodes Xi and all the Y electrodes Yi are biased to a predetermined potential, row selection is performed in a predetermined sequence, and a negative scan pulse Py is applied to one Y electrode Yi corresponding to the selected row. In correspondence to the scan pulse Py, an address pulse Pa is applied to address electrodes Aj corresponding to the display cells to be lighted. As a result, address discharge occurs in the display cells to be lighted, forming desired wall charges necessary for sustaining the lighted state during the sustain period TS.

In the sustain period TS, all the address electrodes Aj are biased to a positive potential to prevent unwanted discharge, and a sustain pulse Ps is applied alternately to the X electrodes Xi and the Y electrodes Yi. The sustain pulse Ps is a pulse with a voltage lower than a discharge start voltage. Each time the sustain pulse Ps is applied, surface discharge occurs in the display cells in which the wall charges were formed in the address period TA, that is, the selected display cells, and the display cells emit light.

Although description has been given in terms of the case where write-type addressing is performed as an example, when erase-type addressing is performed, it is only necessary that: the entire surface is uniformly charged in the reset period TR; in the address period TA, address discharge is made to occur in the display cells not to be lighted to erase unwanted wall charges, thereby leaving the wall charges in the display cells to be lighted.

Also, the drive waveform illustrated in FIG. 3 is a mere example, and the drive waveform according to the present invention is not limited to this, and various changes are possible.

According to the first embodiment described above, when the power consumption value of the address driver 17 calculated by the power calculation circuit 14 is equal to or exceeding a target value, the filter characteristics of the low pass filter 12 are controlled so as to lower the cutoff frequency, thereby suppressing high-frequency components in input frame data Df (display image data). Meanwhile, when the power consumption value of the address driver 17 is lower than the target value, the filter characteristics of the low pass filter 12 are controlled so as to raise the cutoff frequency within the range not exceeding a predetermined range. In other words, the amount of suppression of high-frequency components in input frame data Df is controlled according to the power consumption value of the address driver 17. Also, when filtering is performed by means of the low pass filter 12, filtering is performed on display data in the arrangement sequence of the display cells for the horizontal direction.

Consequently, when the power consumption value of the address driver 17 is equal to or exceeding the target value, high-frequency components in the input frame data Df are suppressed, enabling reduction of the number of potential changes in the address electrodes Aj. Also, the power consumed by the address driver 17 mainly includes charge/discharge power between the address electrodes Aj and the electrodes Xi and Yi and charge/discharge power between the address electrodes Aj, and thus, filtering is performed on the display data in the arrangement sequence of the display cells, enabling direct suppression of potential changes between adjacent address electrodes Aj. Accordingly, the power consumption of the address driver 17 is suppressed to a value equal to or lower than the target value image while suppressing quality deterioration of an displayed image with a simple circuit configuration, i.e., without complicating the circuit configuration, enabling reduction of power consumption.

Also, the amount of suppression of potential changes in the address electrodes Aj is determined by the cutoff frequency that is based on the pitch of display data. Accordingly, comparing the case where filtering is performed in the arrangement sequence of the display cells regardless of R, G or B and the case where filtering is performed on display cells by the same color, making distinction among R, G and B, the cutoff frequency based on the data pitch is the same, but in the spatial frequency in an actual image, the cutoff frequency is higher when filtering is performed in the arrangement sequence of the display cells, compared to when filtering is performed on the display cells by the same color (in this case, the cutoff frequency is based on the pitch three times the pitch of cells), enabling suppression of image blurring.

### Second Embodiment

Next, a second embodiment will be described.

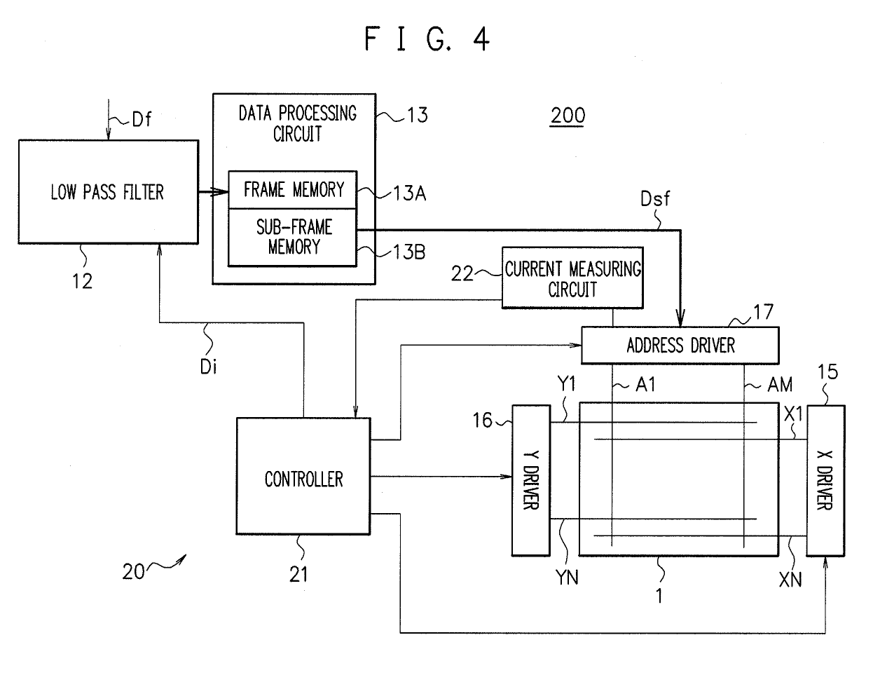

FIG. 4 is a diagram illustrating an example configuration of a plasma display device according to a second embodiment of the present invention. In FIG. 4, the same numerals and symbols are given to the blocks and the like having the same functions as the blocks and the like illustrated in FIG. 1, and the overlapping explanation will be omitted. Also, a drive sequence for the plasma display device according to the second embodiment is similar to that according to the first embodiment.

In the plasma display device 100 according to the first embodiment, the power consumption value of the address driver 17 is obtained by calculation based on the sub-frame data Dsf, and the characteristics of the low pass filter 12 are controlled according to the power consumption value. In a plasma display device 200 according to the second embodiment, which is illustrated in FIG. 4, a current supplied to the address driver 17 is measured, and the characteristics of the low pass filter 12 are controlled according to the measurement result.

Since a power value can be obtained by multiplying the value of the current by the value of the power supply voltage, the measured value of the current supplied to the address driver 17 can be used as an index of the power consumed by the address driver 17. In the second embodiment, frame data Df is filtered based on the value of the current supplied to the address driver 17 to suppress high-frequency components as appropriate, thereby reducing the power consumption of the address driver 17.

The plasma display device 200 according to the second embodiment, as illustrated in FIG. 4, includes an AC-type PDP 1 and a drive unit 20 for the PDP 1.

The drive unit 20, to which pixel-based frame data Df indicating the brightness levels (grayscale levels) of each of colors, R, G and B, are input from an external device such a TV tuner or a computer together with various types of synchronization signals, is provided for selectively lighting numerous display cells constituting a screen with M columns and N rows. The drive unit 20 includes a controller 21, a low pass filter 12, a data processing circuit 13, an X driver 15, a Y driver 16, an address driver 17 and a current measuring circuit 22.

The controller 21 controls the low pass filter 12, the X driver 15, the Y driver 16 and the address driver 17 based on externally-input signals (the frame data Df and the various types of synchronization signals).

Also, the controller 21 is supplied by the current measuring circuit 22 with the result of measurement of the value of the current supplied to the address driver 17, and determines the coefficient of the low pass filter 12 based on the measurement result and outputs coefficient designation data Di. For example, when the value of the current supplied to the address driver 17 is equal to or exceeds a predetermined value, the controller 21 decreases the value of ω₀ (the cutoff frequency of the low pass filter 12), and when the measured value of the current is lower than the predetermined value, the controller 21 increases the value of ω₀ within the range not exceeding ω₀ₘₐₓ.

The current measuring circuit 22 measures the value of a current actually supplied to the address driver 17, and outputs the measurement result to the controller 21.

According to the second embodiment, the filter characteristics of the low pass filter 12 are controlled according to the value of the current supplied to the address driver 17, which is measured by the current measuring circuit 22, so as to properly suppress high-frequency components in the frame data Df. Consequently, the power consumption of the address driver 17 can be suppressed to a value equal to or lower than a target value while suppressing image quality deterioration with a simple circuit configuration, enabling reduction of power consumption.

### Third Embodiment

Next, a third embodiment will be described.

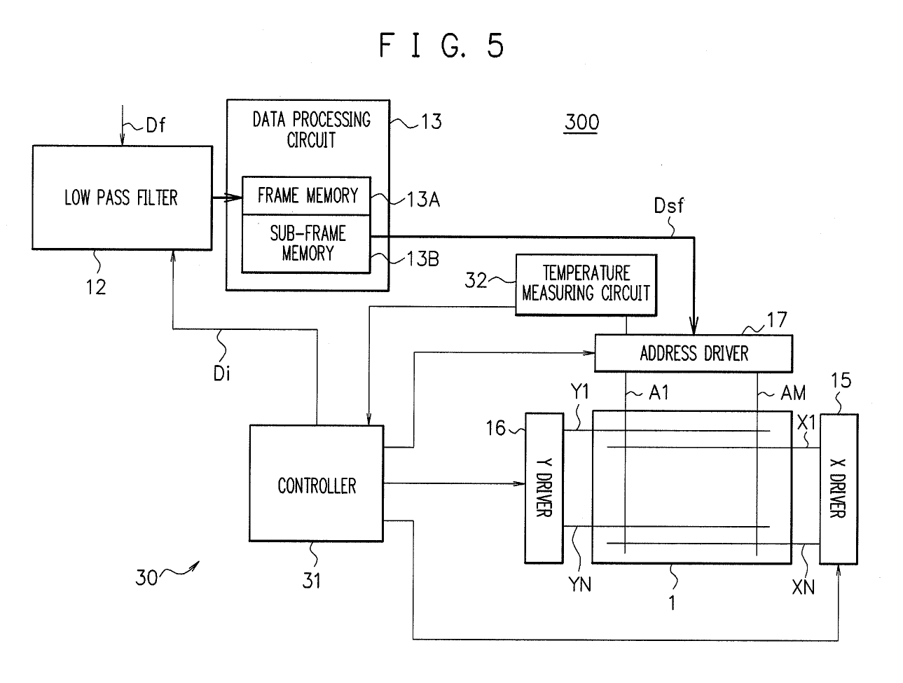

FIG. 5 is a diagram illustrating an example configuration of a plasma display device according to a third embodiment of the present invention. In FIG. 5, the same numerals and symbols are given to the blocks and the like having the same functions as the blocks and the like illustrated in FIG. 1, and the overlapping explanation will be omitted. Also, a drive sequence for the plasma display device according to the third embodiment is similar to that according to the first embodiment.

A plasma display device 300 according to the third embodiment, which is illustrated in FIG. 5, measures the temperature of the address driver 17 and controls the characteristics of the low pass filter 12 based on the measurement result. Here, since the temperature of a driver is higher as the power consumption is larger, the measured temperature of the address driver 17 can be used as an index of the power consumed by the address driver 17. In the third embodiment, frame data Df is filtered based on the temperature of the address driver 17 to suppress high-frequency components as appropriate, thereby reducing the power consumption of the address driver 17.

The plasma display device 300 according to the third embodiment, as illustrated in FIG. 5, includes an AC-type PDP 1 and a drive unit 30 for the PDP 1.

The drive unit 30, to which pixel-based frame data Df indicating the brightness levels (grayscale levels) of each of colors, R, G and B, are input from an external device such a TV tuner or a computer together with various types of synchronization signals, is provided for selectively lighting numerous display cells constituting a screen with M columns and N rows. The drive unit 30 includes a controller 31, a low pass filter 12, a data processing circuit 13, an X driver 15, a Y driver 16, an address driver 17 and a temperature measuring circuit 32.

The controller 31 controls the low pass filter 12, the X driver 15, the Y driver 16 and the address driver 17 based on externally-input signals (the frame data Df and the various types of synchronization signals).

Also, the controller 31 is supplied by the temperature measuring circuit 32 with the result of measurement of the temperature of the address driver 17, and determines the coefficient of the low pass filter 12 based on the measurement result and outputs coefficient designation data Di. For example, if the temperature of the address driver 17 is equal to or exceeds a predetermined temperature, the controller 31 decreases the value of ω₀ (the cutoff frequency of the low pass filter 12), and if the measured temperature is lower than the predetermined temperature, the controller 31 increases the value of ω₀ within the range not exceeding ω₀ₘₐₓ.

The temperature measuring circuit 32 measures the temperature of the address driver 17, and outputs the measurement result to the controller 31. In a plasma display device, generally, a circuit for enabling monitoring of the temperature of a driver is provided, and thus, it may be used as the temperature measuring circuit 32 in the present embodiment.

According to the third embodiment, the filter characteristics of the low pass filter 12 are controlled according to the temperature of the address driver 17, which is measured by the temperature measuring circuit 32, so as to properly suppress high-frequency components in the frame data Df. Consequently, the power consumption of the address driver 17 can be reduced while suppressing image quality deterioration with a simple circuit configuration. Also, since control is performed based on the temperature of the address driver 17, damage of the address driver 17 by heat can reliably be prevented, enabling protection of the address driver 17.

### Fourth Embodiment

Next, a fourth embodiment will be described.

Although the plasma display devices according to the first to third embodiments are configured to filter externally-input frame data Df by means of the low pass filter 12, sub-frame data Dsf may be filtered by means of a low pass filter. A plasma display device according to a fourth embodiment, which will be described below, enables filtering of sub-frame data Dsf obtained as a result of processing by a data processing circuit 13, for suppressing high-frequency components.

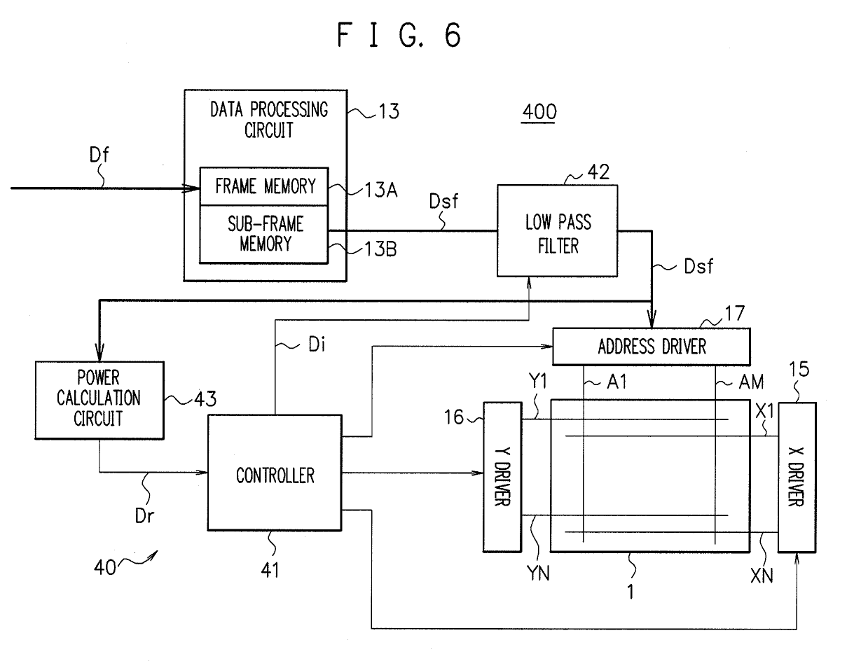

FIG. 6 is a diagram illustrating an example configuration of the plasma display device according to the fourth embodiment of the present invention. In FIG. 6, the same numerals and symbols are given to the blocks and the like having the same functions as the blocks and the like illustrated in FIG. 1, and the overlapping explanation will be omitted. Also, a drive sequence for the plasma display device according to the fourth embodiment is similar to that according to the first embodiment.

A plasma display device 400 according to the fourth embodiment, as illustrated in FIG. 6, includes an AC-type PDP 1 and a drive unit 40 for the PDP 1.

The drive unit 40, to which pixel-based frame data Df indicating the brightness levels (grayscale levels) of each of colors, R, G and B, are input from an external device such a TV tuner or a computer together with various types of synchronization signals, is provided for selectively lighting numerous display cells constituting a screen with M columns and N rows. The drive unit 40 includes a controller 41, low pass filters 42, a power calculation circuit 43, a data processing circuit 13, an X driver 15, a Y driver 16 and an address driver 17.

The controller 41 controls the low pass filters 42, the X driver 15, the Y driver 16 and the address driver 17 based on externally-input signals (the frame data Df and the various types of synchronization signals). Also, the controller 41 is supplied with the power consumption value of the address driver 17 obtained by the power calculation circuit 43, and determines the coefficients of the low pass filters 42 based on the power consumption value and outputs coefficient designation data Di.

Each low pass filter 42 is a filter capable of suppressing high-frequency components in input data, and filters sub-frame data Dsf output from the data processing circuit 13. The low pass filters 42 are provided independently from one another corresponding to respective plural sub-frames constituting one frame. The filter characteristics of the low pass filters 42 are controlled by the coefficient designation data Di from the controller 41, and, for example, the cutoff frequencies of the low pass filters 42 are controlled according to the coefficient designation data Di.

The power calculation circuit 43 is configured in a manner similar to the power calculation circuit 14 in the first embodiment, and calculates the power consumption value of the address driver 17 based on the sub-frame data Dsf filtered by the low pass filter 42. The power calculation circuit 43 outputs data Dr, which indicates the power consumption value obtained as the calculation result, to the controller 41.

For the plasma display device 400 according to the fourth embodiment, which is illustrated in FIG. 6, Li_{f} in expression (1) in the first embodiment may be replaced with sub-frame data. However, when sub-frame data is input to the address driver 17, it is necessary to quantize the sub-frame data to “0” or “1”. Therefore, data L_{d} input to the address driver 17 after being filtered by the low pass filter 42 are quantized according to expression (10).

[Formula 9]

L_{d}=0 (L_{f}<0.5)

L_{d}=1 (L_{f}≧0.5) (10)

In expression (10), L_{f} is a data value after filtering by means of the low pass filter 42.

The plasma display device 400 according to the fourth embodiment is similar to the plasma display device 100 according to the first embodiment in terms of the other points, and thus, a description thereof will be omitted.

Also, the index according to the present embodiment is not limited to the power consumption value of the address driver 17 calculated based on sub-frame data Dsf, but it is possible to actually measure a current supplied to the address driver 17 or the temperature of the address driver 17, and control the characteristics of the low pass filters 42 according to the measurement result as in the second and third embodiments.

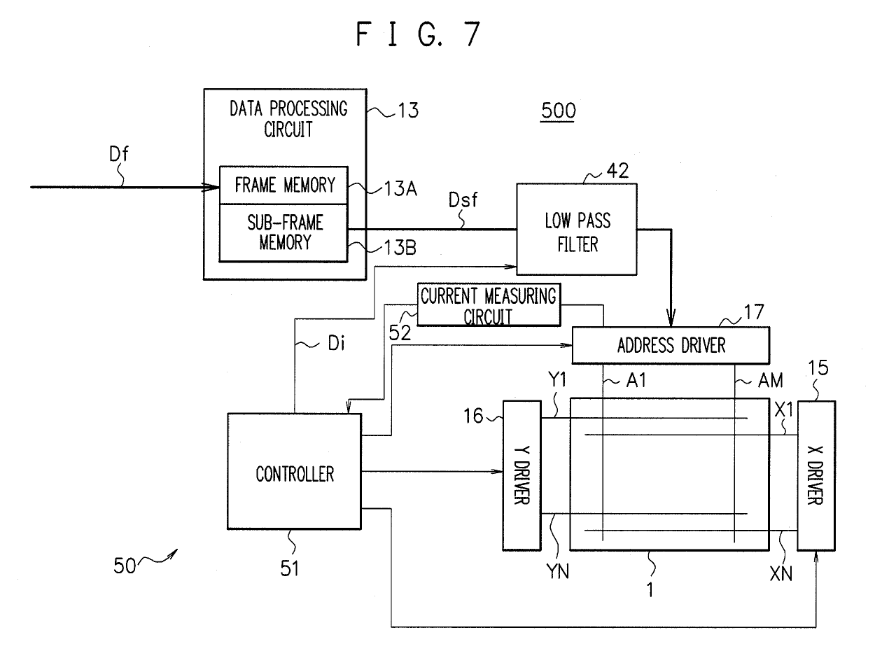

FIG. 7 is another example configuration of the plasma display device according to the fourth embodiment of the present invention. In FIG. 7, the same numerals and symbols are given to the blocks and the like having the same functions as the blocks and the like illustrated in FIGS. 1 and 6, and the overlapping explanation will be omitted. A plasma display device 500, which is illustrated in FIG. 7, measures a current supplied to an address driver 17 and controls the characteristics of low pass filters 42 that filter subframe data Dsf, according to the measurement results.

The plasma display device 500 includes an AC-type PDP 1 and a drive unit 50 for the PDP 1.

The drive unit 50, to which pixel-based frame data Df indicating the brightness levels (grayscale levels) of each of colors, R, G and B, are input from an external device such a TV tuner or a computer together with various types of synchronization signals, is provided for selectively lighting numerous display cells constituting a screen with M columns and N rows. The drive unit 50 includes a controller 51, low pass filters 42, a data processing circuit 13, an X driver 15, a Y driver 16, an address driver 17 and a current measuring circuit 52.

The controller 51 controls the low pass filters 42, the X driver 15, the Y driver 16 and the address driver 17 based on externally-input signals (the frame data Df and the various types of synchronization signals). Also, the controller 51 is supplied by the current measuring circuit 52 with the results of measurement of the value of the current supplied to the address driver 17, and determines the coefficients of the low pass filters 42 based on the measurement results and outputs coefficient designation data Di.

The current measuring circuit 52 measures the value of a current actually supplied to the address driver 17, and outputs the measurement result to the controller 51.

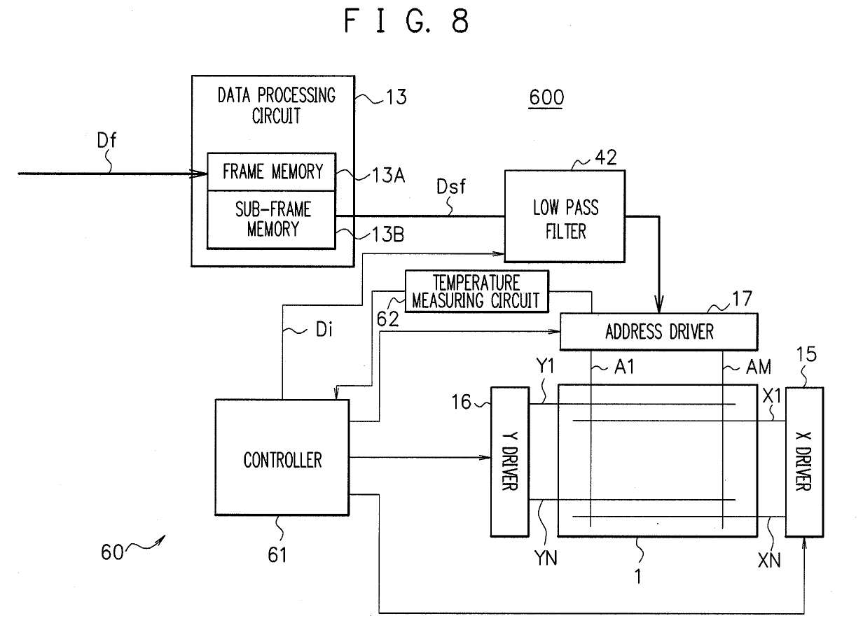

FIG. 8 is a diagram illustrating another example configuration of the plasma display device according to the fourth embodiment of the present invention. In FIG. 8, the same numerals and symbols are given to the blocks and the like having the same functions as the blocks and the like illustrated in FIGS. 1 and 6, and the overlapping explanation will be omitted. A plasma display device 600, which is illustrated in FIG. 8, measures the temperature of the address driver 17, and controls the characteristics of the low pass filters 42 that filter sub-frame data Dsf, according to the measurement results.

The plasma display device 600 includes an AC-type PDP 1 and a drive unit 60 for the PDP 1.

The drive unit 60, to which pixel-based frame data Df indicating the brightness levels (grayscale levels) of each of colors, R, G and B, are input from an external device such a TV tuner or a computer together with various types of synchronization signals, is provided for selectively lighting numerous display cells constituting a screen with M columns and N rows. The drive unit 60 includes a controller 61, low pass filters 42, a data processing circuit 13, an X driver 15, a Y driver 16, an address driver 17 and a temperature measuring circuit 62.

The controller 61 controls the low-pass filters 42, the X driver 15, the Y driver 16 and the address driver 17 based on externally-input signal (the frame data Df and the various types of synchronization signals). Also, the controller 61 is supplied by the current measuring circuit 62 with the results of measurement of the value of the current supplied to the address driver 17, and determines the coefficients of the low pass filters 42 based on the measurement results and outputs coefficient designation data Di.

The temperature measuring circuit 62 measures the temperature of the address driver 17 and outputs the measurement result to the controller 61.

As described above, the fourth embodiment enables reduction of the power consumption of the address driver 17 while suppressing image quality deterioration with a simple circuit configuration as in the first to third embodiments. Also, sub-frame data Dsf, which are the exact data for controlling the address driver 17, are filtered by each sub-frame data Dsf as a unit by means of the low pass filter 42, enabling control for each sub-frame. For example, filtering is not performed on data for a more significant sub-frame (or a group of more significant sub-frames) having high brightness weighting, and filtering is performed only on data for a less significant sub-frame (or a group of less significant sub-frames) having low brightness weighting by means of the low pass filter(s) 42, enabling reduction of the power consumption of the address driver 17 while suppressing enlargement of an error in grayscale.

Although in the plasma display device according to the fourth embodiment, a low pass filter 42 is provided for each sub-frame, it is possible to provide only one low pass filter 42 and perform the control to change the coefficient for each sub-frame. Furthermore, it is also possible to provide not one low pass filter 42, but a plurality of low pass filters 42 to properly control the coefficients, thereby enabling the plurality of low pass filters 42 to be used for several sub-frames.

Furthermore, although in the first to fourth embodiments, only any one of the power consumption value of the address driver 17 obtained by calculation, the measured value of the current supplied to the address driver 17, and the measured temperature of the address driver 17 is used as an index of the power consumed by the address driver 17, the index is not limited to this, and any plural indexes may be used for control.

Where plural indexes are used, a target value is set for each of the indexes, and control is performed so that: when at least one index is equal to or exceeds the target value, the cutoff frequency of the low pass filter is lowered; and when all the indexes are lower than the respective target values, the cutoff frequency of the low pass filter is raised.

Furthermore, as in the first and fourth embodiments, where the power consumed by the address driver 17 is obtained by means of calculation, it is also possible that: the screen is divided into a plurality of areas; the power consumption value of the address driver 17 is calculated for each of the areas; and filtering is performed by means of the low pass filter so as to suppress high-frequency components only for areas that consume a large amount of power. More specifically, it is possible that: a target value for the power consumption of the address driver 17 is set for each of the divided areas; and filtering is performed according to the result of comparison between the power consumption value obtained by calculation and the target value. Such control is suitable for, for example, an image showing a moving image on a part of a screen and a still image on the other part of the screen.

Also, all of the above-described embodiments are mere examples of embodying the present invention to practice the present invention, and the technical scope of the present invention should not be limited by these embodiments. In other words, the present invention can be practiced in various manners within the scope not deviating from the technical idea or the essential features thereof.

### INDUSTRIAL APPLICABILITY

According to the present invention, the number of changes in the potentials of the address electrodes can be reduced according to the display data with a simple circuit configuration, enabling suppression of image quality deterioration and reduction of the power consumption of the address driver.

What is claimed is:

1. A plasma display device comprising:
a filter filtering display data;
a plurality of address electrodes selecting light emission or no light emission of display cells; and
an address driver driving the address electrodes based on the filtered display data,
wherein a characteristic of the filter is controlled based on index information relating to power consumption of the address driver, and the filtering is performed on the display data in an arrangement sequence of display cells for a direction perpendicular to a direction in which the address electrodes extends on a display screen displaying an image displayed based on the display data.

2. The plasma display device according to claim 1,
wherein the filtering can be performed on the display data for display cells for a same color for the direction perpendicular to the direction in which the address electrodes extends on the display screen, and
filtering the display data in the arrangement sequence of display cells or filtering the display data for display cells for a same color is selected according to the power consumption of the address driver obtained based on the index information.

3. The plasma display device according to claim 1,
wherein the filtering is performed on the display data on the display screen for the direction in which the address electrodes extends.

4. The plasma display device according to claim 1,
wherein the filter is controlled so that if it is determined based on the index information that the power consumption of the address driver is equal to or exceeds a predetermined value, a cutoff frequency is lowered so as to suppress a high-frequency component in the display data, and if it is determined that the power consumption of the address driver is lower than the predetermined value, the cutoff frequency is raised.

5. The plasma display device according to claim 1,
wherein the filtering is performed by each of display data for a plurality of sub-frames, the display data being obtained by conversion of display data for one frame.

6. The plasma display device according to claim 5,
wherein the plurality of sub-frames are classified into a group of sub-frames each having high brightness weighting and a group of sub-frames each having low brightness weighting, and the filtering is performed only on display data for a sub-frame belonging to the group of sub-frames each having low brightness weighting.

7. The plasma display device according to claim 1,
wherein the index information is the power consumption value of the address driver obtained by calculation using the display data.

8. The plasma display device according to claim 7,
wherein the display screen is divided into a plurality of areas, a power value is calculated for each of the areas, and the filtering is performed on display data for the area based on the power value.

9. The plasma display device according to claim 1,
wherein the index information is information of a current supplied to the address driver, the current being measured by a current measuring circuit.

10. The plasma display device according to claim 1,
wherein the index information is information of a temperature of the address driver, the temperature being measured by a temperature measuring circuit.
